(19) United States
(12) Patent Application Publication
(10) Pub. No.: US 2024/0078133 A1
(43) Pub. Date: Mar. 7, 2024

(54) INFORMATION PROCESSING APPARATUS, METHOD, AND NON-TRANSITORY COMPUTER READABLE MEDIUM

(71) Applicant: FUJIFILM Business Innovation Corp., Tokyo (JP)

(72) Inventor: Tatsuyuki TANAKA, Kanagawa (JP)

(73) Assignee: FUJIFILM Business Innovation Corp., Tokyo (JP)

(21) Appl. No.: 18/184,717

(22) Filed: Mar. 16, 2023

(30) Foreign Application Priority Data
Sep. 5, 2022 (JP) 2022-140795

(51) Int. Cl. G06F 9/48; G06F 9/50

(52) U.S. Cl. CPC G06F 9/4881; G06F 9/5072

(57) ABSTRACT

An information processing apparatus that serves as a host apparatus that achieves synchronization of data with a different information processing apparatus by causing the different information processing apparatus to transmit the data in response to a request made via a synchronization path, communication through which is startable only from a side of the host apparatus, includes: a processor configured to: establish a communication path between the different information processing apparatus and the host apparatus, separately from the synchronization path, by transmitting a path establishment request to the different information processing apparatus via the synchronization path, communication through the communication path being startable from either side; and achieve the data synchronization in response to an instruction for the data synchronization in a case where the instruction is provided from the different information processing apparatus via the communication path.

### CROSS-REFERENCE TO RELATED APPLICATIONS

This application is based on and claims priority under 35 USC 119 from Japanese Patent Application No. 2022-140795 filed Sep. 5, 2022.

### BACKGROUND

### (i) Technical Field

The present disclosure relates to an information processing apparatus, a method, and a non-transitory computer readable medium.

### (ii) Related Art

There has recently been known a technique of providing a cloud service through cooperation between a multi-function device as a real device and a virtual device on the cloud corresponding to the multi-function device. This enables a user to use a service such as image processing provided by the multi-function device by accessing the virtual device on the cloud, without directly accessing the multi-function device.

In order for the virtual device to provide the same service as that of the multi-function device, the multi-function device and the virtual device are synchronized with each other at all times to maintain the same data or be correlated with the same data. Synchronization is started in response to the multi-function device sending a request for update to the virtual device.

The multi-function device is occasionally turned off or brought into a power-saving mode to save power, and may not be synchronized with the virtual device when the multi-function device is in a power-saving state. Thus, the multi-function device sends a request for update to the virtual device when the multi-function device recovers from the power-saving state, and is synchronized by retrieving data updated while the multi-function device may not be synchronized.

Related techniques are disclosed in Japanese Unexamined Patent Application Publication No. 2016-082334, Japanese Unexamined Patent Application Publication No. 2019-144949, and Japanese Unexamined Patent Application Publication No. 2017-010321.

### SUMMARY

In a type of synchronization in which data synchronization is achieved between information processing apparatuses by causing a different information processing apparatus to transmit data in response to a request from a host apparatus, data synchronization may not be achieved for data updated on the different information processing apparatus side unless a request is sent from the host apparatus in the case where data are updated on the different information processing apparatus side.

Aspects of non-limiting embodiments of the present disclosure relate to achieving data synchronization in response to an instruction for synchronization from a different information processing apparatus in the case where data synchronization is achieved by causing the different information processing apparatus to transmit data in response to a request made via a synchronization path, communication through which is startable only from the host apparatus side.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus that serves as a host apparatus that achieves synchronization of data with a different information processing apparatus by causing the different information processing apparatus to transmit the data in response to a request made via a synchronization path, communication through which is startable only from a side of the host apparatus, the information processing apparatus including a processor configured to: establish a communication path between the different information processing apparatus and the host apparatus, separately from the synchronization path, by transmitting a path establishment request to the different information processing apparatus via the synchronization path, communication through the communication path being startable from either side; and achieve the data synchronization in response to an instruction for the data synchronization in a case where the instruction is provided from the different information processing apparatus via the communication path.

### BRIEF DESCRIPTION OF THE DRAWINGS

An exemplary embodiment of the present disclosure will be described in detail based on the following figures, wherein:

FIG. 1 illustrates the overall configuration of a service system and the block configuration of devices according to the present exemplary embodiment;

FIG. 2 illustrates an example of the data configuration of influence degree determination information stored in an influence degree determination information storage section according to the present exemplary embodiment;

FIG. 3 is a sequence diagram illustrating a synchronization process according to the present exemplary embodiment; and

FIG. 4 is a flowchart illustrating a job control process according to the present exemplary embodiment.

### DETAILED DESCRIPTION

An exemplary embodiment of the present disclosure will be described below with reference to the drawings.

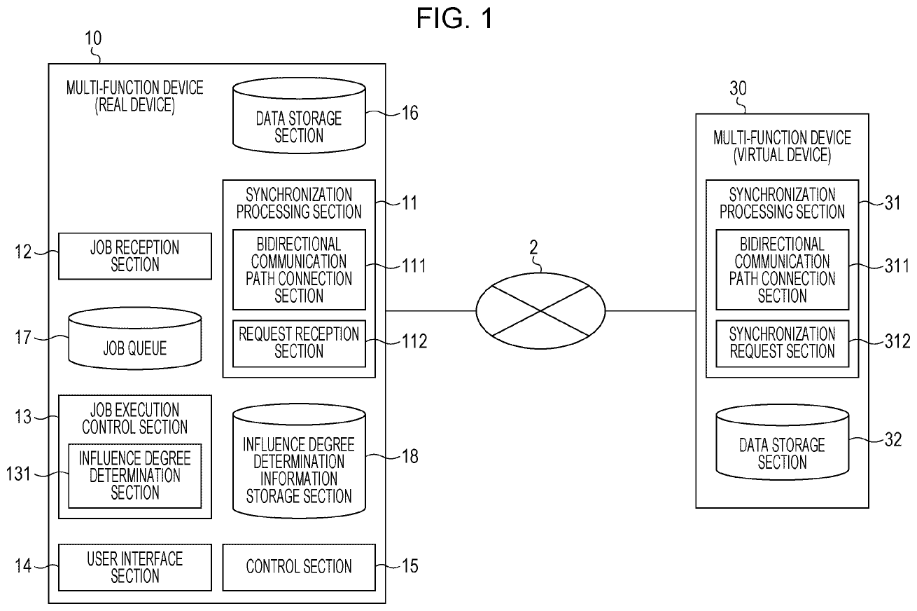

FIG. 1 illustrates the overall configuration of a service system and the block configuration of devices according to the present exemplary embodiment. FIG. 1 illustrates a configuration in which a multi-function device 10 installed in an on-premise environment and a multi-function device 30 formed on the cloud are connected to each other via a network 2 such as the Internet. The multi-function device 10 is a real device physically installed in the on-premise environment, and thus will also be referred to as a “real device 10” in the following description. Meanwhile, the multi-function device 30 is a multi-function device virtually formed on the cloud, and thus will also be referred to as a “virtual device 30” in the following description. While the real device 10 and the virtual device 30 are conveniently described as making a one-to-one correspondence in the present exemplary embodiment, a plurality of real devices 10 may be correlated with a single virtual device 30.

The multi-function device 10 according to the present exemplary embodiment is a form of an image forming apparatus that provides various functions such as a print function, a copy function, and a scanner function, and includes a built-in information processing apparatus (also referred to as a “computer”). The multi-function device 10 according to the present exemplary embodiment may be implemented by a general-purpose hardware configuration that has existed since previously. That is, the multi-function device 10 includes a central processing unit (CPU), a storage unit such as a read only memory (ROM), a random access memory (RAM), and a hard disk drive (HDD) that stores image data, a confidential box, etc., an operation panel that serves as a user interface, a communication unit that implements near-field wireless communication with the network 2 such as the Internet or an integrated circuit (IC) card carried by a user, and a scanner, a print engine, etc. that are necessary to provide the various functions. A card reader may be connected to support an IC card.

The virtual device 30 is a form of a virtual image forming apparatus implemented by one or a plurality of computers, and includes an information processing apparatus.

In order for the real device 10 and the virtual device 30 to provide equivalent services to a user, it is necessary to achieve data synchronization between the real device 10 and the virtual device 30. “Data synchronization” basically refers to the two devices holding the same data. A part (also referred to a “subset”) of software that exists in the virtual device 30 occasionally exists in the multi-function device 10. In this manner, the term “data synchronization” should not be construed to exclusively indicate that the two devices hold perfectly the same data. In the present exemplary embodiment, “data synchronization” refers to the multi-function devices 10 and 30 cooperating with each other so that each of the devices is able to provide a service that should be provided using the data.

The “data” include an application and data to be used by the application, various setting values for the multi-function devices 10 and 30, etc. That is, in the present exemplary embodiment, electronic data to be referenced during operation of the multi-function devices 10 and 30 are collectively referred to as “data”. In the case where the data correspond to an application, it is necessary to synchronize the data for upgrading, function addition, etc.

In FIG. 1, the real device 10 includes a synchronization processing section 11, a job reception section 12, a job execution control section 13, a user interface section 14, a control section 15, a data storage section 16, a job queue 17, and an influence degree determination information storage section 18. In FIG. 1, only constituent elements that are necessary to describe the present exemplary embodiment are illustrated, and the other constituent elements such as constituent elements that implement a print function provided by the multi-function device 10, for example, are not illustrated.

The synchronization processing section 11 performs a synchronization process of achieving data synchronization with the virtual device 30. In the synchronization process, the synchronization processing section 11 achieves data synchronization via a synchronization path, as previously, and achieves data synchronization via a bidirectional communication path, which is characteristic of the present exemplary embodiment. The synchronization processing section 11 includes a bidirectional communication path connection section 111 and a request receiving section 112. The bidirectional communication path connection section 111 establishes a bidirectional communication path with the virtual device 30. The request receiving section 112 receives a synchronization request sent from the virtual device 30 via the bidirectional communication path.

In the present exemplary embodiment, as described above, two types of communication routes, namely the “synchronization path” and the “bidirectional communication path”, are established between the real device 10 and the virtual device 30. The “synchronization path” is a communication route which has been used since previously, and communication through which is startable only from the real device 10 side. In the case where the synchronization path is used, the virtual device 30 is able to transmit update data to the real device 10 by responding to a request from the real device 10, which allows the real device 10 to be synchronized with the update data in the virtual device 30. The term “update data” refers to data that have been subjected to an update such as addition, change, and deletion in the virtual device 30 and that do not match data possessed by the real device 10 and thus need to be synchronized. The “bidirectional communication path” is a communication route which is established separately from the synchronization path, and communication through which is startable from either of the multi-function devices 10 and 30, that is, from either side.

The job reception section 12 receives a job from a user, and puts the received job in the job queue 17. The job execution control section 13 controls execution of jobs queuing in the job queue 17. An influence degree determination section 131 included in the job execution control section 13 references influence degree determination information, and determines the degree of influence of update data on execution of a job. The user interface section 14 receives a user operation on the operation panel, and displays information on the operation panel. The control section 15 controls overall operation of the multi-function device 10, such as display on the operation panel and recovery from the power-saving state, for example.

The data storage section 16 stores at least data to be synchronized with the virtual device 30. The job queue 17 stores jobs received by the job reception section 12.

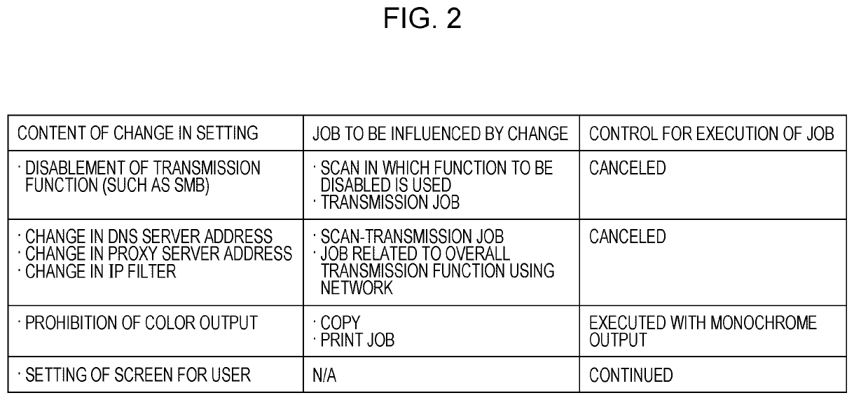

FIG. 2 illustrates an example of the data configuration of influence degree determination information stored in the influence degree determination information storage section 18 according to the present exemplary embodiment. The influence degree determination information is information set and registered in advance in the influence degree determination information storage section 18, and to be referenced by the influence degree determination section 131. The influence degree determination information is set by correlating “content of change in setting”, “job to be influenced by change”, and “control for execution of job”. The content of a change in setting of update data is set in the “content of change in setting”. The type of a job to be influenced by the change in setting of update data is set in the “job to be influenced by change”. The content of control for execution of the job is set in the “control for execution of job”.

The constituent elements 11 to 15 of the real device 10 are implemented through cooperative operation between a computer that forms the real device 10 and a program that operates on a CPU mounted on the computer. The storage sections 16 to 18 are implemented by an HDD mounted on the real device 10. Alternatively, a RAM or a storage unit provided externally may be used by way of a network.

The virtual device 30 includes a synchronization processing section 31 and a data storage section 32. The virtual device 30 is a virtual multi-function device of the real device 10, and thus basically has functions that are equivalent to those of the real device 10. Constituent elements that are not used to describe the present exemplary embodiment are not illustrated. The illustrated constituent elements, e.g. the synchronization processing section 31, may have slightly different functions.

The synchronization processing section 31 performs a synchronization process of achieving data synchronization between the multi-function devices 10 and 30 through cooperative operation with the synchronization processing section 11. The synchronization processing section 31 includes a bidirectional communication path connection section 311 and a synchronization request section 312. The bidirectional communication path connection section 311 establishes a bidirectional communication path with the real device 10 through cooperative operation with the bidirectional communication path connection section 111. The synchronization request section 312 requests the real device 10 to synchronize update data via the bidirectional communication path. The data storage section 32 stores at least update data to be synchronized with the real device 10.

The synchronization processing section 31 of the virtual device 30 is implemented through cooperative operation between a computer mounted on the virtual device 30 and a program that operates on a CPU mounted on the computer. The data storage section 32 is implemented by an HDD mounted on the virtual device 30. Alternatively, a RAM or a storage unit provided on the cloud may be used.

The program used in the present exemplary embodiment may be not only provided by a communication unit but also provided as stored in a computer-readable storage medium such as a Universal Serial Bus (USB) memory. The program provided from the communication unit or the storage medium is installed in a computer, and sequentially executed by a CPU of the computer to perform various processes.

As discussed earlier, the multi-function devices 10 and 30 provide equivalent services. A synchronization process performed in order to achieve data synchronization between the multi-function devices 10 and 30 to that end is started by the real device 10 sending a request to the virtual device 30 via the synchronization path at a predetermined timing. Since the real device 10 is not able to make a request when the real device 10 is turned off or brought into a power-saving mode to be in a power-saving state, synchronization may not be achieved for data updated on the virtual device 30 side when the real device 10 is in the power-saving state. Thus, the virtual device 30 holds data (“update data” mentioned above) updated while synchronization may not be achieved in the data storage section 32.

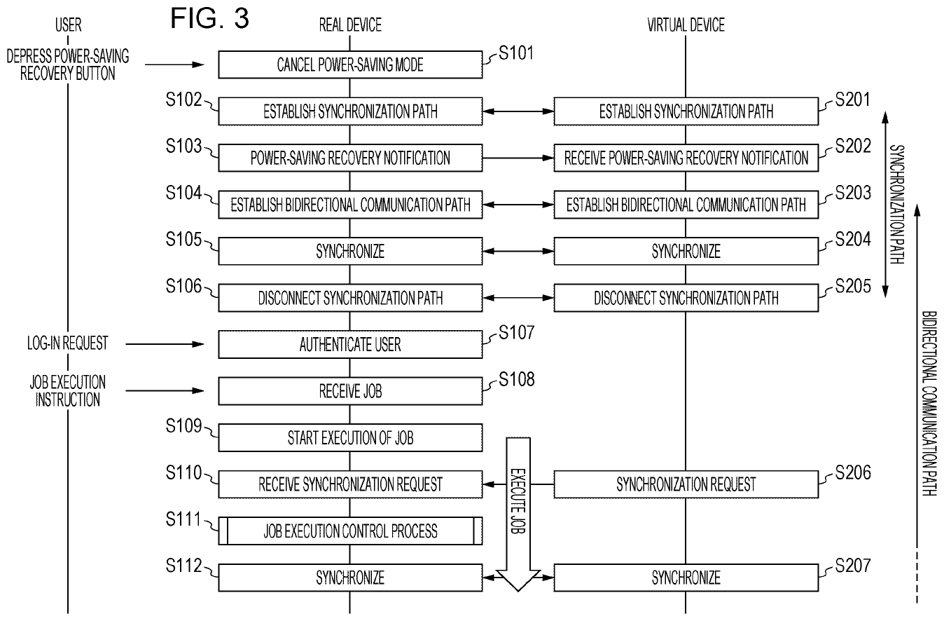

A synchronization process performed after recovery from the power-saving state in response to a user operation and a process performed when a user instructs execution of a job will be described with reference to the sequence diagram illustrated in FIG. 3.

When a user desires to cause the real device 10 to execute a job, the user depresses a power-saving recovery button of the real device 10 in a power-saving state. The control section 15 cancels a power-saving mode in response to the button operation by the user (step 101). When the power-saving mode is canceled, the synchronization processing section 11 establishes a synchronization path with the virtual device 30 through cooperative operation with the synchronization processing section 31 of the virtual device 30 (steps 102 and 201). Subsequently, the synchronization processing section 11 notifies the virtual device 30 that the real device 10 has recovered from the power-saving state via the synchronization path (step 103). This notification corresponds to an inquiry about the presence or absence of update data. In the present exemplary embodiment, this notification also corresponds to a request to establish a bidirectional communication path. The process itself may be the same as that performed previously.

When the notification of recovery from the power-saving state is received (step 202), the synchronization processing section 31 establishes a bidirectional communication path with the real device 10 through cooperative operation with the synchronization processing section 11 of the real device 10 (steps 104 and 203). The path is specifically established in the following procedures.

That is, the synchronization processing section 31 transmits a Uniform Resource Locator (URL), which is information that specifies the destination of connection of a bidirectional communication path, to the real device 10. The synchronization processing section 11 of the real device 10 establishes a bidirectional communication path by connecting to the destination of connection specified from the URL received from the virtual device 30. The procedures for establishing a path using a URL may be the same as those used previously.

While the synchronization processing section 11 is described as acquiring a URL from the virtual device 30 after recovery from the power-saving state, the synchronization processing section 11 may acquire a URL before being brought into the power-saving state and establish a bidirectional communication path using the URL acquired beforehand upon recovery from the power-saving state.

After that, the synchronization processing section 11 and the synchronization processing section 31 cooperate with each other to achieve synchronization with the update data in the virtual device 30 (steps 105 and 204), and thereafter disconnect the synchronization path (steps 106 and 205).

Respective periods for which a synchronization path and a bidirectional communication path are established are indicated by arrows on the right side of FIG. 3. Control of a process in which a synchronization path is used may be performed as previously, and thus synchronization is achieved using a synchronization path upon recovery from the power-saving state in the present exemplary embodiment. Synchronization may be achieved using a bidirectional communication path that has been established. Once a bidirectional communication path is established, the bidirectional communication path is kept established during operation, that is, after the real device 10 recovers from the power-saving state and until the real device 10 is brought into the power-saving state again.

The operation panel of the real device 10 becomes usable when data synchronization is finished, and thus the user makes a request to log in by operating the operation panel. Alternatively, the user may make a request to log in to the real device 10 by presenting an IC card to be read etc. The control section 15 authenticates the user in response to a request to log in from the user (step 107). The description here is continued on the assumption that the user is successfully authenticated.

Upon logging in to the real device 10, the user provides an instruction to execute a job by specifying the job to be executed using the operation panel etc.

The job reception section 12 receives a job, execution of which has been instructed by the user (step 108), and registers the job in the job queue 17. Then, the job execution control section 13 retrieves the job specified by the user from the job queue 17, and starts execution of the job (step 109).

It is assumed that data are updated in the virtual device 30 and there arises a need to achieve synchronization. In this case, the synchronization request section 312 requests the real device 10 to execute a synchronization process via the bidirectional communication path (step 206).

Previously, only a synchronization path, communication through which is startable only from the real device 10 side, has been established, and thus it has been necessary for the virtual device 30 to wait until a request is made from the real device 10. In the present exemplary embodiment, a bidirectional communication path, communication through which is startable also from the virtual device 30 side, has been established, and thus the virtual device 30 is able to request the real device 10 to execute a synchronization process via the bidirectional communication path as described above.

When the request receiving section 112 of the real device 10 receives a synchronization request via the bidirectional communication path (step 110), the synchronization processing section 11 and the synchronization processing section 31 cooperate with each other to achieve synchronization with the update data in the virtual device 30 (steps 112 and 207).

With the present exemplary embodiment, it is possible to achieve synchronization with update data in accordance with a synchronization instruction from the virtual device 30 in the manner described above.

While synchronization is achieved in response to a synchronization request from the virtual device 30, there may be a case where the job started in step 109 has not been finished yet when the synchronization request is received. The unfinished job occasionally uses data that need to be synchronized, that is, data corresponding to the update data in the virtual device 30. The update data are data not synchronized between the real device 10 and the virtual device 30, or in other words data not updated in the real device 10, and thus there may occur problems, such as failure in a process due to a mismatch in data in cooperative operation between the real device 10 and the virtual device 30 and leakage of information due to important update such as correction of a security vulnerability not being implemented, if such data are used in a job.

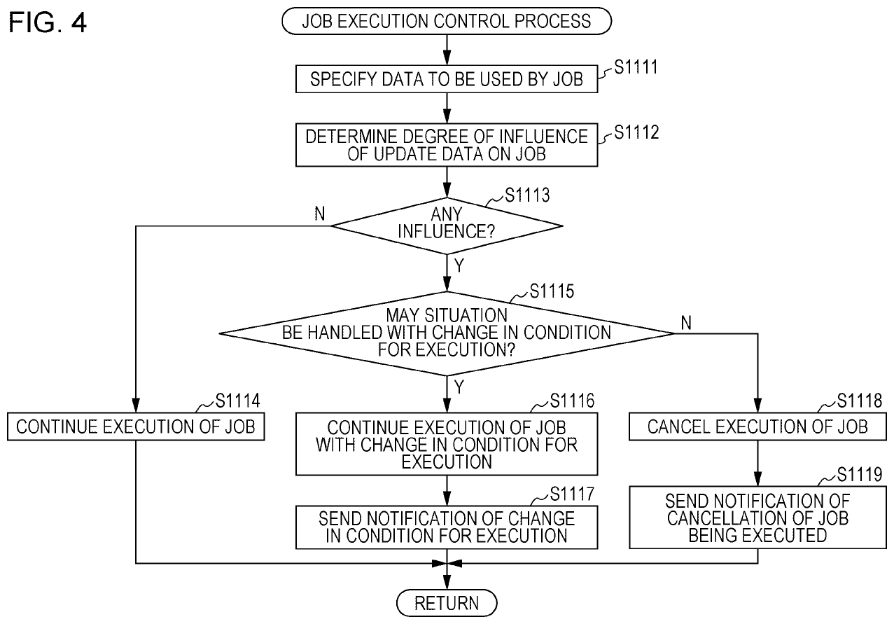

Thus, the job execution control section 13 according to the present exemplary embodiment controls execution of a job in accordance with the degree of influence on execution of the job in the case where data synchronization is achieved in response to a synchronization instruction from the virtual device 30. That is, when a synchronization request is received, the job execution control section 13 controls execution of a job being executed before a synchronization process is executed or concurrently with a synchronization process (step 111). A job execution control process according to the present exemplary embodiment will be described with reference to the flowchart illustrated in FIG. 4.

The influence degree determination section 131 of the job execution control section 13 specifies data, that is, an application and various data, to be used by the job being executed (step 1111). Meanwhile, the influence degree determination section 131 references a list of update data transmitted from the virtual device 30 when a synchronization request is made, and determines the degree of influence of the update data on execution of the job (step 1112). One of step 1111 and step 1112 may be performed before the other, or the two steps may be performed concurrently.

It is assumed that a proxy server address has been changed on the virtual device 30 side in the case where the job being executed is a scan-transmission job in which an image obtained by scanning is transmitted using the HyperText Transfer Protocol (http), for example. In this case, the proxy server address is included in update data. It is estimated that the change in data of the proxy server address influences execution of the scan-transmission job. That is, there is a possibility that transmission made using the http is not finished normally. It is assumed that an application to be used for printing has been upgraded on the virtual device 30 side in the case where the job being executed is a print job. In this case, this application is included in update data. It is estimated that the update of this application influences execution of the print job. There is a possibility that printing is not finished normally because of an error, as a mismatch is caused in the content of processing in the case where image processing is performed through cooperation between the real device 10 and the virtual device 30, for example. It is assumed that a change in setting to prohibit color printing is made on the virtual device 30 side in the case where the job being executed is a print job with color printing. In this case, setting to prohibit color printing is included in update data. While the change in setting to prohibit color printing disables color printing, printing itself may be continued if the condition for execution of the job is changed from color printing to monochrome printing, and may be finished normally. In the case where the job being executed is a print job and data to be used for printing are not included in update data, it is estimated that the current data synchronization (steps 112 and 207) does not influence execution of the print job.

The influence degree determination section 131 according to the present exemplary embodiment determines the degree of influence described above with reference to the influence degree determination information illustrated in FIG. 2. The job execution control section 13 controls execution of a job based on the result of determining the degree of influence with reference to the influence degree determination information.

That is, in the case where it is determined that the job being executed is not influenced by executing synchronization (N in step 1113), the job execution control section 13 continues execution of the job (step 1114).

In the case where it is determined that the job being executed is influenced by executing synchronization (Y in step 1113), on the other hand, the job execution control section 13 switches the process in accordance with the degree of influence on the job. That is, in the case where it is determined that the job may be continuously executed if the condition for execution is changed as with the print job with color printing described above (Y in step 1115), the job execution control section 13 continues execution of the job by changing the condition for execution (step 1116).

It is conceivable that a user that requests execution of a job does not desire execution of the job with the condition for execution changed. Thus, the job execution control section 13 notifies a user that has made an instruction to execute a job that the condition for execution has been changed (step 1117). For example, the job execution control section 13 temporarily suspends execution of a job, and checks with the user whether or not to execute the job by displaying on the operation panel a message saying that the condition for execution has been changed and inquiring whether or not to execute the job while execution of the job is suspended. Then, the job execution control section 13 resumes execution of the job in the case where the user selects to execute the job, and cancels execution of the job in the case where the user does not select to execute the job.

While color printing is used as an example of the condition for execution of a job in the above description, this is not limiting. For example, printing on A3 paper may be prohibited and only printing on A4 paper may be allowed in the case where double-sided printing is prohibited and only single-sided printing is allowed in setting about the attribute of a job.

In the case where it is determined that execution of a job is influenced if the condition for execution is changed as with the scan-transmission job described above (N in step 1115), meanwhile, the job execution control section 13 cancels execution of the job in accordance with setting for the influence degree determination information (step 1118). Then, the job execution control section 13 notifies the user that execution of the job has been canceled (step 1119).

With the present exemplary embodiment, as described above, an instruction to start synchronization may be provided also from the virtual device 30 side, by establishing a bidirectional communication path after the real device 10 recovers from the power-saving state, thereafter maintaining a state in which the bidirectional communication path is established at all times during operation of the multi-function devices 10 and 30, and the real device 10 monitoring communication via the bidirectional communication path at all times. In the case where synchronization is achieved in response to an instruction from the virtual device 30, the real device 10 controls execution of a job in consideration of the influence of the synchronization on the job being executed.

While the present exemplary embodiment has been described with focus on a job being executed, a job registered in the job queue 17, that is, a job before being executed, may be handled in the same manner as the job being executed discussed earlier, since there is a possibility that such a job is executed before the synchronization process in steps 112 and 207 is started. That is, the condition for execution is changed in the case where the situation may be handled by changing the condition for execution. In this case, a user that has provided an instruction to execute the job may be notified, and an inquiry about whether or not to change the condition for execution may be made, in the same manner as described above. The condition for execution is changed if the user permits a change in the condition for execution, and deletes the job from the job queue 17 if not. In the case where the situation may not be handled by changing the condition for execution, the job is deleted from the job queue 17, and the user is notified that the job has been deleted.

Also when a user is operating the operation panel in an attempt to register a job, the user may be notified that synchronization is to be achieved in response to a request from the virtual device 30 through display on the operation panel etc. If it is possible to specify whether or not data corresponding to update data, such as the attribute of a job being set, e.g. a print job, and the attribute such as for color printing, are used, only a user that sets a job related to the update data may be notified.

The job according to the present exemplary embodiment is not limited to a job to be executed in accordance with an execution instruction from a user that has operated the operation panel, and may be a job sent by way of a network, for example.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing apparatus that serves as a host apparatus that achieves synchronization of data with a different information processing apparatus by causing the different information processing apparatus to transmit the data in response to a request made via a synchronization path, communication through which is startable only from a side of the host apparatus, the information processing apparatus comprising:
a processor configured to:
   establish a communication path between the different information processing apparatus and the host apparatus, separately from the synchronization path, by transmitting a path establishment request to the different information processing apparatus via the synchronization path, communication through the communication path being startable from either side; and
   achieve the data synchronization in response to an instruction for the data synchronization in a case where the instruction is provided from the different information processing apparatus via the communication path.
      (((2)))

The information processing apparatus according to (((1))),
wherein the communication path is kept established during operation.
   (((3)))

The information processing apparatus according to (((1))),
wherein the processor is configured to control execution of a job in accordance with a degree of influence on the execution of the job in a case where the data synchronization is achieved in response to the instruction from the different information processing apparatus.
   (((4)))

The information processing apparatus according to (((3))),
wherein the processor is configured to cancel the execution of the job in a case where the data synchronization influences the execution of the job.
   (((5)))

The information processing apparatus according to (((4))),
wherein the processor is configured to notify an execution requester that the execution of the job has been canceled.
   (((6)))

The information processing apparatus according to (((3))),
wherein the processor is configured to execute the job with a condition for the execution of the job changed in a case where the data synchronization influences the execution of the job but does not influence the execution of the job if the condition for the execution of the job is changed.
   (((7)))

The information processing apparatus according to (((6))),
wherein the processor is configured to notify an execution requester that the condition for the execution of the job has been changed.
   (((8)))

The information processing apparatus according to (((3))),
wherein the processor is configured to execute the job without any intervention in a case where the data synchronization does not influence the execution of the job.
   (((9)))

The information processing apparatus according to (((1))),
wherein the processor is configured to notify a user that has set a job related to the data that the data synchronization is to be achieved in response to an instruction from the different information processing apparatus.
   (((10)))

The information processing apparatus according to (((1))),
wherein the different information processing apparatus is formed on a cloud.
   (((11)))

A program causing a computer to execute a process, the computer serving as a host computer and achieving synchronization of data with a different computer by causing the different computer to transmit the data in response to a request made via a synchronization path, communication through which is startable only from a side of the host computer, the process comprising:
establishing a communication path between the different computer and the host computer, separately from the synchronization path, by transmitting a path establishment request to the different computer via the synchronization path, communication through the communication path being startable from either side; and
achieving the data synchronization in response to an instruction for the data synchronization in a case where the instruction is provided from the different computer via the communication path.

What is claimed is:

1. An information processing apparatus that serves as a host apparatus that achieves synchronization of data with a different information processing apparatus by causing the different information processing apparatus to transmit the data in response to a request made via a synchronization path, communication through which is startable only from a side of the host apparatus, the information processing apparatus comprising:
a processor configured to:
establish a communication path between the different information processing apparatus and the host apparatus, separately from the synchronization path, by transmitting a path establishment request to the different information processing apparatus via the synchronization path, communication through the communication path being startable from either side; and
achieve the data synchronization in response to an instruction for the data synchronization in a case where the instruction is provided from the different information processing apparatus via the communication path.

2. The information processing apparatus according to claim 1,
wherein the communication path is kept established during operation.

3. The information processing apparatus according to claim 1,
wherein the processor is configured to control execution of a job in accordance with a degree of influence on the execution of the job in a case where the data synchronization is achieved in response to the instruction from the different information processing apparatus.

4. The information processing apparatus according to claim 3,
wherein the processor is configured to cancel the execution of the job in a case where the data synchronization influences the execution of the job.

5. The information processing apparatus according to claim 4,
wherein the processor is configured to notify an execution requester that the execution of the job has been canceled.

6. The information processing apparatus according to claim 3,
wherein the processor is configured to execute the job with a condition for the execution of the job changed in a case where the data synchronization influences the execution of the job but does not influence the execution of the job if the condition for the execution of the job is changed.

7. The information processing apparatus according to claim 6,
wherein the processor is configured to notify an execution requester that the condition for the execution of the job has been changed.

8. The information processing apparatus according to claim 3,
wherein the processor is configured to execute the job without any intervention in a case where the data synchronization does not influence the execution of the job.

9. The information processing apparatus according to claim 1,
wherein the processor is configured to notify a user that has set a job related to the data that the data synchronization is to be achieved in response to an instruction from the different information processing apparatus.

10. The information processing apparatus according to claim 1,
wherein the different information processing apparatus is formed on a cloud.

11. A method of causing a computer to process information, the computer serving as a host computer and achieving synchronization of data with a different computer by causing the different computer to transmit the data in response to a request made via a synchronization path, communication through which is startable only from a side of the host computer, the method comprising:
establishing a communication path between the different computer and the host computer, separately from the synchronization path, by transmitting a path establishment request to the different computer via the synchronization path, communication through the communication path being startable from either side, and
achieving the data synchronization in response to an instruction for the data synchronization in a case where the instruction is provided from the different computer via the communication path.

12. A non-transitory computer readable medium storing a program causing a computer to execute a process, the computer serving as a host computer and achieving synchronization of data with a different computer by causing the different computer to transmit the data in response to a request made via a synchronization path, communication through which is startable only from a side of the host computer, the process comprising:
establishing a communication path between the different computer and the host computer, separately from the synchronization path, by transmitting a path establishment request to the different computer via the synchronization path, communication through the communication path being startable from either side, and
achieving the data synchronization in response to an instruction for the data synchronization in a case where the instruction is provided from the different computer via the communication path.

13. An information processing apparatus that serves as a host apparatus that achieves synchronization of data with a different information processing apparatus by causing the different information processing apparatus to transmit the data in response to a request made via a synchronization path, communication through which is startable only from a side of the host apparatus, the information processing apparatus comprising:
means for establishing a communication path between the different information processing apparatus and the host apparatus, separately from the synchronization path, by transmitting a path establishment request to the different information processing apparatus via the synchronization path, communication through the communication path being startable from either side; and
means for achieving the data synchronization in response to an instruction for the data synchronization in a case where the instruction is provided from the different information processing apparatus via the communication path.
